(19) United States
(12) Patent Application Publication
(10) Pub. No.: US 2004/0184972 A1
(43) Pub. Date: Sep. 23, 2004

(54) Rapid sterilization of an air filter medium

(76) Inventors: Daniel W Kelly, Kingsport, TN (US); Kimberly Kelly-Winterberg, Knoxville, TN (US); Daniel M Sherman, Louisville, TN (US); Suzanne South, Seymor, TN (US)

Correspondence Address: PITTS AND BRITTIAN P C, P O BOX 51295, KNOXVILLE, TN, 37950-1295, US

(21) Appl. No.: 10/491,767

(22) PCT Filed: Oct. 2, 2002
(86) PCT No.: PCT/US02/31510

Related U.S. Application Data
(60) Provisional application No. 60/326,189, filed on Oct. 2, 2001.

(51) Int. Cl. B01J 19/08; B01J 19/12

(52) U.S. Cl. 422/186.04; 204/164

(57) ABSTRACT

A method and apparatus (10) for sterilizing a filter medium (14) includes the steps of providing a filter element (14), an atmospheric plasma device (12) capable of generating and convecting reactive oxidative species, and locating the filter element (14) downstream of the plasma device (12) whereby both the surface and the bulk of a filter media (14) is exposed to the reactive oxidative species generated from the atmospheric plasma effecting sterilization of the filter element (14). The atmospheric plasma device (12) is either an RF, a DC pulse, or an AC power supply to generate the atmospheric plasma and create the reactive oxidative species.

### CROSS-REFERENCE TO RELATED APPLICATIONS

This application claims the benefit of U.S. Provisional Application No. 60/326,189, filed Oct. 2, 2001.

### STATEMENT REGARDING FEDERALLY SPONSORED RESEARCH OR DEVELOPMENT

Not Applicable

### BACKGROUND OF THE INVENTION

1. Field of Invention

This invention pertains to air filtration. More specifically, this invention relates to a sterilizing air filter and method for using the same, the sterilizing air filter being disposed downstream from an atmospheric plasma capable of generating and convecting reactive oxidative species, whereby both the surface and the bulk of a filter medium is exposed to the reactive oxidative species generated from the atmospheric plasma effecting sterilization of the filter element.

2. Description of the Related Art

In the field of air filtration, it is known that indoor air pollution is a contributing cause of tuberculosis, legionella, sinusitis, allergies, bronchitis, asthma, and other health problems. Not only are airborne bacteria and viruses extremely small in size, but they propagate rapidly. The typical diameter of a bacterium is a few micrometers. Viruses are a fraction of the size of bacteria. The size of these pathogens makes their capture on a filter medium difficult. Due to their rapid propagation rate, once captured, the pathogens have a tendency to propagate on the filter surface and migrate through the filter.

The vast majority of airborne pathogens are uniquely adapted to spread in indoor environments. The conditions of temperature, humidity and protection from sunlight and from oxidants which man controls for his own comfort serve also to protect pathogens during their exposed and vulnerable period when they are transmitted from one person to the next. Most airborne pathogens die out rapidly in outdoor air but as species, most individuals depend entirely on man and his indoor environments for their propagation.

While not limited to these microorganisms, exemplary microorganisms of concern include bacteria, fungi, viruses and spores. Bacteria are composed of a rigid cell wall that provides protection from the environment and support, a selectively permeable phospholipid bilayer membrane, and internally, the cytoplasm. Within the cytoplasm is the nucleic acid DNA, referred to as the nucleoid. Based upon cell wall structure, bacteria are divided into two major groups, Gram positive and Gram negative cells. One important classification criterion for bacteria is their ability to produce endospores. Two endospore forming genera are Gram positive Bacillus (Bacillus anthracis, e.g.) and Clostridium. Endospores are produced in response to environmental stress and cannot be destroyed easily. They remain capable of germination into vegetative cells for many years.

Molds are incredibly resilient and adaptable. Molds gain the nutrients they need through the decomposition of organic matter. Most molds found in indoor air get their nutrients from wood, paper, paint, fabric, dust, and foods. To germinate molds need only food, water and time. Molds elicit a variety of health responses in humans. The severity of the impact depends upon the type and amount of mold present as well as the susceptibility and sensitivity of the individual. Humans are exposed to molds via ingestion and more importantly inhalation and skin contact with mold or mold infested material.

Viruses are acellular and exist in two states—extracellular and intracellular. Being parasitic, they replicate only in host cells. Viruses are simple in structure, containing either DNA or RNA surrounded by a protein coat which protects the nucleic acids from degradation. External to the protein coat, many viruses possess an envelope composed of lipids, carbohydrates, or proteins.

The air can be full of transient populations of microorganisms, but there are none that actually live in the air. Many microbes are killed by outdoor air, as a result of sunlight, temperature extremes, dehydration, oxygen and pollution. The indoors, however, with its engineered environment, tends to favor the survival of microorganisms including human pathogens. Relative to outdoor air, the quality of indoor air can be much worse. The EPA makes three statements regarding this point. First, indoor air can be 20 to 70 times worse than outdoor air. Second, on a day with the highest pollution index, indoor air can be worse to breathe than the air outdoors. Third, over half of our homes and offices are suffering from a form of sick building syndrome. These statements are particularly alarming since Americans spend 90% of their time indoors.

An example of the seriousness of biological contamination in indoor air is Legionnaires Disease. Legionella bacteria were first discovered in 1976 as the result of the Legionnaires Disease outbreak in Philadelphia which affected 200 individuals. This organism was found to be the cause of a similar outbreak the previous year at the same hotel as well as a series of mysterious epidemics going back 50 years.

Legionnaires Disease is a pneumonia which attacks 2-5% of those exposed. Between 5-15% of those who contract legionella die from it. The most susceptible individuals include the elderly and those with suppressed immune systems or respiratory illness. It incubates in human hosts within 2-10 days and will not abate without medication. Estimates of the number of cases vary from 25,000 to 50,000 a year in the U.S. There have been over 50 separate outbreaks.

Tuberculosis is spread via the air through inhalation. Mycobacterium tuberculosis is carried in airborne particles known as droplet nuclei that are generated when persons with pulmonary or laryngeal tuberculosis sneeze, cough, speak, spit, or sing. Droplet nuclei may also be generated by medical procedures such as respiratory therapy, bronchoscopy, endotracheal intubation, open abscess irrigation, and autopsy. The droplet nuclei are so small (1-5 μm) that they can be suspended indefinitely in the air and be spread throughout a facility by the HVAC system. The probability that a susceptible person will become infected with Mycobacterium tuberculosis depends primarily upon the concentration of infectious droplet nuclei in the air and the exposure duration. Unlike other airborne microorganisms such as Legionella pneumophila which require large aerosolized populations of bacteria in order to produce an infection, TB exposure has no minimum infectious dose. It has been demonstrated that one TB bacillus is enough to result in infection.

In recent years, the transmission of tuberculosis in health care facilities has reached epidemic proportions. These transmissions have included outbreaks of multidrug-resistant strains of Mycobacterium tuberculosis that have produced many deaths. A 1992 study found that 10% of patients in a large hospital's HIV unit had TB, and that half had acquired the infection since admission. More than half the nurses working on the same floor had a positive tuberculin test, indicating they were infected with the bacterium.

Conventional ventilation systems possess multiple intakes and a blower to move air through the system. Even prior to the October 2001 anthrax attacks, it was widely held that the biggest threat to domestic security was from terrorists releasing agents in a building in which there is a closed ventilation system. Release of an agent at the fresh air intake would contaminate all floors within minutes since the agent would rapidly spread through the supply duct. Most current HVAC systems have only low-efficiency filtration, incapable of consistently capturing biological warfare agents.

The difficulty encountered in neutralizing these agents emphasizes the need for reliable, yet practical, means to prevent their spread. This situation was demonstrated with the unleashing of weapons grade anthrax spores through the United States' mail system mentioned above. In the aftermath of the attacks on the World Trade Center and the Pentagon in September, 2001, a number of anthrax-laden letters were delivered through the postal system and reached into the offices of government leaders and other persons of high position. These anthrax attacks caused the postal system in some areas to completely shut down until steps were taken to prevent the spread of anthrax.

Providing high quality, safe indoor air is hindered by the extremely small size of microorganisms and their ability to grow on filter material. The typical diameter of bacteria is a few micrometers, but viruses can be 1/100 this diameter. It is well known that the effective filtration of particles less than one micrometer is difficult. It is also known that the organisms that are captured by the filter can propagate on the filter surface and migrate through the filter, necessitating frequent filter changes.

The use of High Efficiency Particulate Air (HEPA) filters is the best commercial method for the capture of organisms contained in ventilation air. HEPA filters are defined by an array of glass fibers providing a thick medium to capture microorganisms. Due to the thickness of the filter, however, a large pressure drop results. The pressure drop limits the implementation of HEPA filtration in schools, clinics, government buildings, and other institutions. Furthermore, HEPA filters do not kill or inactivate captured microorganisms. The microorganisms can continue to grow and flourish, and the filter can eventually become a vehicle for the distribution of the organisms they were installed to remove. As a result, HEPA filters must be replaced two to three times per year. While HEPA filters are capable of capturing 0.3 micrometer diameter particles at greater than 99% efficiency, capture efficiency is worst for particle diameters measuring 0.3 microns, but improves as particle sizes either increase or decrease.

The use of atmospheric plasma to produce reactive oxidative species which are convected downstream to effect sterilization of air filtration media can address both of these challenges. The reactive oxidative species created by atmospheric plasma can neutralize microorganisms both on the surface and throughout the bulk of air filtration media.

Many types of organic compounds have been exposed to gas discharges. It has been found that this exposure leads to oxidation, with complete oxidation resulting in CO₂ and H₂O as byproducts. These exposures were all performed in the gas phase, and little is known about the efficacy of heterogeneous oxidation of these compounds. It is known that the oxidation is generated by the oxygen containing radical species created by the discharge, principally OH and atomic oxygen. Hydrolysis is known to decompose nerve agents. In this case the OH radical would be expected to accelerate the process of hydrolysis.

Early work on the use of plasmas for biological destruction was performed by Mizuno and Ito, “An Electrostatic Precipitator Using Packed Ferroelectric Pellet Layer for Dust Collection” Proceedings of the Third Symposium on the Transfer and Utilization of Particulate Control Technology, March, 1981, who employed a dielectric pellet reactor to destroy yeast cells. A high field applied across the dielectric pellets caused localized discharges to occur at the pellet contact points. When yeast cells were deposited on the pellets, it was found that the electrical energization of the reactor could destroy up to 50% of the cells. Complete destruction could also be achieved at longer exposures, but this was attributed to thermal destruction. While this demonstration clearly showed that biological entities could be killed by exposure to plasma, the non-uniform nature of the pellet reactor discharge could not accomplish complete sterilization.

The One Atmosphere Uniform Glow Discharge Plasma (OAUGDP™) Reactor was developed at the University of Tennessee by J. R. Roth, as disclosed in the '583 patent listed above, and is currently being developed and commercialized by Atmospheric Glow Technologies, LLC, the assignee of the present invention. The process is applied at room temperature and sterilizes fabrics, films and solid materials in seconds to minutes. The plasma reactor predominantly operates in atmospheric air, but all other gases including but not limited to oxygen, helium, nitrogen and carbon dioxide at or above normal pressure. The balance of the operational parameters and device characteristics eliminates the need for vacuum systems and batch processing are not necessary. The system is composed of an RF power supply and a pair of electrodes separated by varying distances. The operating conditions and treatment times required for room temperature sterilization of a variety of porous and non-porous substrates seeded with a number of different microorganisms has been established.

In previous experiments, atmospheric plasma processes have been very effective in killing Gram positive and Gram negative bacteria in a time-frame of seconds, and fungi and bacterial endospores in a time-frame of minutes. When Staphylococcus aureus (Gram positive) and Escherichia coli (Gram negative) bacterial cells (10⁶-10⁸ cells) were placed on filter paper or one ounce polypropylene fabric and exposed to OAUGDP™, no viable cells were detected after a short 18 sec exposure time. Further, when bacterial cells were embedded into solid growth media and exposed to the plasma, sterilization was achieved with a 60 second exposure. Recently, atmospheric plasma exposures effectively destroyed ten million Bacillus subtilis var niger and Bacillus anthracis endospores within eight minutes on a surface 16 inches away from the plasma source. These spores are considered very difficult to kill. Solid culture media (agar) sterilized by plasma exposure was subsequently able to support normal cell growth, suggesting that the growth medium was not altered or damaged by exposure to the plasma.

Various filtering devices have been produced to filter indoor air. Typical of the art are those devices disclosed in the following U.S. patents:

| Pat. No. | Inventor(s) | Issue Date |
|---|---|---|
| 5,225,167 | L. E. Wetzel | Jul. 6, 1993 |
| 5,387,842 | J. R. Roth et al. | Feb. 7, 1995 |
| 5,403,453 | J. R. Roth et al. | Apr. 4, 1995 |
| 5,405,434 | I. I. Inculet | Apr. 11, 1995 |
| 5,414,324 | J. R. Roth et al. | May 9, 1995 |
| 5,456,972 | J. R. Roth et al. | Oct. 10, 1995 |
| 5,573,577 | C. J. Joannou | Nov. 12, 1996 |
| 5,593,476 | R. R. Coppom | Jan. 14, 1997 |
| 5,669,583 | J. R. Roth | Sep. 23, 1997 |
| 5,938,854 | J. R. Roth | Aug. 17, 1999 |
| 6,146,724 | J. R. Roth | Nov. 14, 2000 |
| 6,245,126 | P. L. Feldman et al. | Jun. 12, 2001 |
| 6,245,132 | P. L. Feldman et al. | Jun. 12, 2001 |

The '577 patent issued to Joannou, the '434 patent issued to Inculet, and the '476 patent issued to Coppom disclose electrically enhanced air filters. Specifically, an electrostatic field is applied to the filter in order to enhance capture on the filter medium.

The '577 patent discloses a device in which pads of dielectric fibers are sandwiched between electrically charged ionizing elements, and grounded screens. The ionizing elements charge the dust particles passing through the filter and at the same time, polarize the fibrous filter pads. In this way, the charged particles are attracted and collected on the fibrous pads with improved efficiency.

The '434 patent discloses an electrostatic filter for purifying air in an HVAC system including a pair of conductive filaments insulated from one another and disposed close together in a substantially parallel side-by-side relationship. Circuitry is provided for applying an electrical potential difference between two conductors. The strong electric fields cause the wire sets to attract fine airborne particulate matter in the vicinity of the filter mesh so that the mesh retains dirt, atmospheric ions, and other very fine particles. Such particles include pollen and bacteria borne by the air stream passing through the mesh which are removed from the air.

The '476 patent discloses a high efficiency air filtration apparatus utilizing a fibrous filter medium that is polarized by a high potential difference which exists between an insulated electrode and an un-insulated electrode. A corona pre-charger is positioned upstream of the electrodes and filter and applies a charge to particles which are removed from the air flow system as they accumulate on the filter surfaces proximal to the insulated electrode.

While electrically enhanced filters such as those discussed above are good candidates for removing sub-micron airborne particles, their capture efficiency decreases due to charge cancellation and fouling of the electronic surfaces. Even if the filtration efficiency was perfect, the microorganisms are still viable and capable of propagating. With such a filter, given enough time, the microorganisms will continue to grow and will be released back into the air, thus negating the purpose of the filter. As a result, these air filters fail to effectively purify indoor air from airborne micro-organisms hazardous to health.

Ultraviolet radiation systems utilize UV radiation in order to destroy microorganisms on the surface of the filters. UV light penetrates the cell walls of microbes causing cellular or genetic damage. The microorganisms are destroyed or become unable to propagate. The '167 patent issued to Wetzel discloses such a method. The primary deficiency of UV systems is that the microorganisms that penetrate deep into the filter are not susceptible to the UV radiation. These organisms continue to grow and in some cases release dangerous toxins into the air stream.

Those patents issued to either Roth or Roth et al., disclose the use of a steady-state glow discharge plasma apparatus in various applications. The apparatus is operated at one atmosphere of pressure. A pair of spaced apart insulated metallic electrodes are energized using low D radio frequency with an rms potential of 1 to 20 KV at 1 to 100 kHz. Air or another gas such as helium or argon is passed between the electrodes. The electrodes are typically charged by a power supply and an impedance matching network adjusted to produce the most stable uniform glow discharge. The airflow through the electrodes is controlled to further assure the non-destructive aspects of the One Atmosphere Uniform Glow Discharge Plasma.

Sterilization of a wide variety of microorganisms has been accomplished using this type of uniform glow discharge plasma. The sterilization is caused by interrupting the integrity of the biological material. This interruption is caused by reactive oxygen species which damage the biological material via toxicity, disruption, and leaking of the macromolecules.

In the discipline of physics, the term “plasma” describes a partially ionized gas composed of ions, electrons and neutral species. This state of matter may be produced by the action of either very high temperatures, strong electric or radio frequency (R.F.) electromagnetic fields. High temperature or “hot” plasmas are represented by celestial light bodies, nuclear explosions and electric arcs. Glow discharge plasmas are produced by free electrons which are energized by an imposed direct current (DC) or R.F. electric fields and then collide with neutral molecules. These neutral molecule collisions transfer energy to the molecules and form a variety of active species including metastables, atomic species, free radicals and ions. These active species are chemically active and/or physically modify the surface of materials and may therefore serve as the basis of new chemical compounds and property modifications of existing compounds.

Low power plasmas known as corona discharges have been widely used in the surface treatment of thermally sensitive materials such as paper, wool and synthetic polymers such as polyethylene, polypropylene, polyolefin, nylon and poly(ethylene terephthalate). Because of their relatively low energy content, corona discharge plasmas can alter the properties of a material surface though the filamentary nature of the corona may damage the surface.

Glow discharge plasmas represent another type of low power density plasma useful for non-destructive material surface modification. However, glow discharge plasmas are commonly generated in low pressure or partial vacuum environments below 10 torr, necessitating batch processing and the use of expensive vacuum systems. Some glow discharges can be generated at atmospheric pressure in a manner such that there is a high degree of spatial uniformity if an ion trapping mechanism is employed.

The '126 and '132 patents issued to Feldman et al. disclose a method of filtering air using a pair of electrodes disposed on either side of a filter element. A DC electrostatic field is applied to the electrodes to produce attracting forces between particulates and microorganisms contained in the air and the filter element. A sterilizing electrical field is intermittently applied concurrently with the electrostatic field. An RF, DC pulse, or AC power supply can be used to generate the sterilizing electrical field.

### BRIEF SUMMARY OF THE INVENTION

The present invention is a method and apparatus for killing airborne microorganisms. The device of the present invention includes a duct through which an air stream laden with microorganisms is directed. The duct defines an inlet and an outlet. In one embodiment, the duct further defines a secondary inlet through which is directed a secondary air stream.

A filter medium is disposed within the duct for capturing the microorganisms suspended in the air stream. The filter medium is adapted to receive and filter the entire air stream. In the alternate embodiment wherein a secondary inlet is defined, the filter medium is disposed downstream of the secondary inlet. The filter medium is a conventional filter such as a surface filter medium, a bulk filter medium, a charged filter medium, or an electrically enhanced filter medium.

A plasma generator is provided for generating an atmospheric plasma. The atmospheric plasma in turn generates reactive oxidative species which are convected toward the filter medium. To this extent, the plasma generator is disposed upstream from the filter medium, either in the air stream laden with microorganisms, or in the secondary air stream. In the former embodiment, the air stream laden with microorganisms serves to convect the reactive oxidative species from the atmospheric plasma toward the filter medium. In the latter embodiment, the secondary air stream is used to convect the reactive oxidative species toward the filter medium. In either embodiment, the microorganisms captured by the filter medium are destroyed by the reactive oxidative species whereby a purified air stream is directed from the filter medium toward the duct outlet.

The plasma generator produces either a radio frequency (RF) electric field, an alternating current (AC) electric field, or a direct current (DC) electric field for generating said atmospheric plasma. In the embodiment wherein an RF electric field is produced, the RF electric field is tuned to trap ions resulting from the atmospheric plasma. In the embodiment wherein a DC electric field is produced, the DC electric field may be pulsed.

The atmospheric plasma generator consists of two sets of electrodes with one set, both sets, or neither set insulated. The electrodes are fabricated from conductive wires, rods, plates, or meshes. The electrodes can be parallel, curved, or tubular. The pair of electrodes comprises one or a combination of these electrode configurations.

The method of the present invention includes the steps of:

providing a duct through which an air stream laden with microorganisms is directed;

providing a plasma generator for generating an atmospheric plasma; providing a filter medium downstream from the plasma generator for capturing the microorganisms suspended in the air stream, the filter media being adapted to receive and filter the entire air stream;

directing the air stream laden with microorganisms toward the filter medium;

capturing the microorganisms in the filter medium;

generating an atmospheric plasma using the plasma generator thereby generating reactive oxidative species within the air stream; and

convecting a sufficient concentration of the reactive oxidative species onto and throughout the filter medium, whereby the microorganisms captured by the filter medium are destroyed and whereby a purified air stream is directed from the filter medium toward the duct outlet.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 is a top plan view, in section, of the device of the present invention, wherein an atmospheric plasma device and filter medium are positioned within an air duct, the filter medium being positioned downstream of the atmospheric plasma device;

FIG. 2 is a top plan view, in section, of an alternate deployment of the device of the present invention, wherein the atmospheric plasma device is disposed in a secondary duct opening into the primary air duct upstream from the filter medium;

FIG. 3 is a top plan view, in section, of a further alternate deployment of the device of the present invention, wherein an atmospheric plasma device is positioned upstream from a filter medium within an air duct, a secondary duct being provided to recirculate air through the atmospheric plasma device and the filter medium, closure devices being provided upstream and downstream from the secondary duct to create a closed loop, and a blower being disposed within the closed loop to generate air flow;

FIG. 4 is a top plan view, in section, of a further alternate deployment of the device of the present invention, wherein a filter medium is positioned within an air duct, and an atmospheric plasma device is positioned within a secondary duct with a blower, closure devices being provided upstream and downstream from the secondary duct to create a closed loop through which air is recirculated through the filter medium and the atmospheric plasma device;

FIG. 5 is a perspective illustration of one configuration of the atmospheric plasma device of the present invention, shown in relation to a filter medium, the atmospheric plasma device including two sets of conducting wires or rods;

FIG. 6 is a perspective illustration of an alternate configuration of the atmospheric plasma device of the present invention shown in relation to a filter medium, the atmospheric plasma device including two sets of conducting wires or rods separated by an electrode plate;

FIG. 7 is a perspective illustration of a further alternate configuration of the atmospheric plasma device of the present invention shown in relation to a filter medium, the atmospheric plasma device including a set of parallel plates;

FIG. 8 is a perspective illustration of a further alternate configuration of the atmospheric plasma device of the present invention shown in relation to a filter medium, the atmospheric plasma device including a set of conducting wires or rods and a mesh disposed parallel to the conducting wires or rods;

FIG. 9 is a perspective illustration of a further alternate configuration of the atmospheric plasma device of the present invention shown in relation to a filter medium, the atmospheric plasma device including a set of parallel plasma panels, each plasma panel being defined by a plate having conducting wires disposed on the surface of at least one side thereof; and

FIG. 10 is a perspective illustration of a further alternate configuration of the atmospheric plasma device of the present invention shown in relation to a filter medium, the atmospheric plasma device including a series of plasma panels, each plasma panel being defined by a plate having conducting wires disposed on the surface of at least one side thereof.

### DETAILED DESCRIPTION OF THE INVENTION

A device for the rapid sterilization of an air filter located downstream from an atmospheric plasma source and a method for using the device are described herein. The device is illustrated at 10 in the figures. Generally, the device 10 of the present invention utilizes reactive oxidative species generated by an atmospheric plasma source 12 disposed upstream from and convected downstream toward a filter medium 14. Captured microorganisms are killed in seconds to minutes. Indirect exposure of the air filter 14 to the atmospheric plasma causes minimal damage to delicate filter material allowing a larger variety of filter material and filter types to be used to trap the microorganisms. Filter types used in association with the present invention include but are not limited to surface filters, bulk filters, electrically enhanced filters, and charged filters. The filter materials include but are not limited to those composed of natural fibers, glass fibers, metallic fibers, or polymer fibers. Further, the location of the filter 14 outside of the electrode array comprising the atmospheric plasma source 12 precludes constraints on the filter thickness. In addition, the present invention allows electrostatic filters to remain charged due to their location outside the vicinity of the atmospheric plasma.

The present invention is used to destroy microorganisms captured on filtration media 14 in order to control indoor air laden with microorganisms such as viruses, endospores, fungi, and bacteria. Such a device 10 and method are useful in areas that are traditionally highly susceptible to airborne pathogens, such as in hospitals and other medical facilities; facilities for which effective control of airborne pathogens would lead to the improved health of its occupants, such as schools and offices; and clean rooms especially for microelectronic fabrication.

When compared to prior methods attempting to perform similar functions, the present invention eliminates the requirement for a robust filter material. The present invention also eliminates the requirement of placing the plasma in direct contact with the filter media. Further, the present invention eliminates the requirement for a complex electrode arrangement to sterilize the entire filter while not obstructing the airflow. Other deficiencies realized in prior methods that are overcome with the present invention include neutralization of embedded static charges on the surface of the filter 14 as a result of an applied voltage; and alteration of the surface properties of the filter 14.

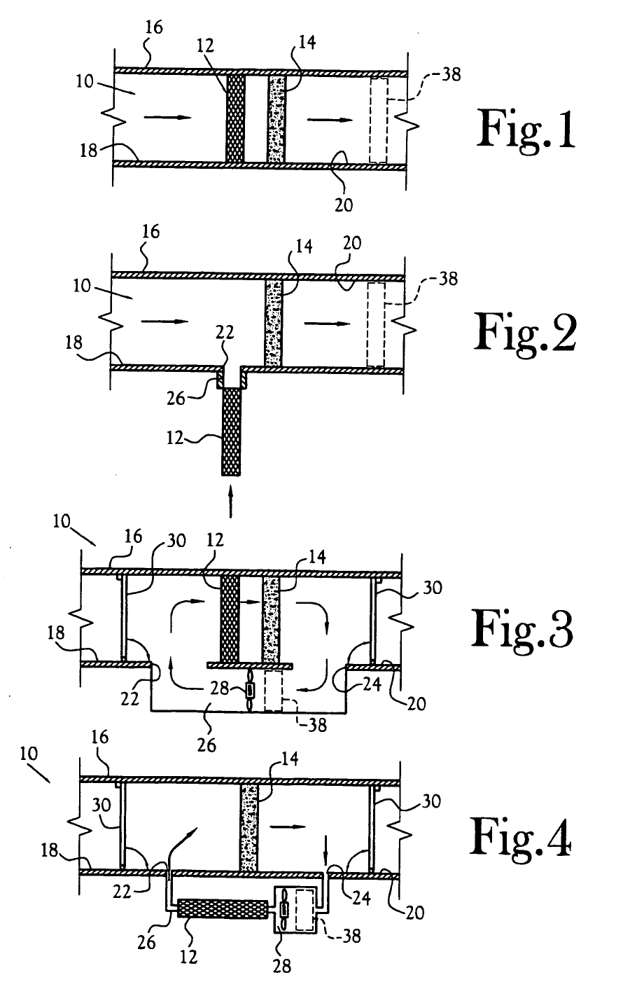

As illustrated in FIGS. 1-4, the device 10 of the present invention is typically positioned within a duct 16 through which an air stream laden with microorganisms is directed. The device 10 of the present invention includes primarily an plasma generator, or atmospheric plasma device (APD) 12, and a filter medium 14. The filter medium 14 is adapted to receive and filter the entire air stream. The filter medium 14 is a conventional filter such as a surface filter, a bulk filter medium, a charged filter medium, or an electrically enhanced filter medium. Compatible filter materials include but are not limited to natural fibers, glass fibers, polymer filters, or metallic filters.

The APD 12 is provided for generating atmospheric plasma via an electric field. The atmospheric plasma in turn generates reactive oxidative species which are convected toward the filter medium 14. To this extent, the APD 12 is disposed upstream from the filter medium 14, either in the air stream laden with microorganisms, or in a secondary air stream. In the former embodiment, the air stream laden with microorganisms serves to convect the reactive oxidative species from the atmospheric plasma toward the filter medium 14. In the latter embodiment, the secondary air stream is used to convect the reactive oxidative species toward the filter medium 14. In either embodiment, the microorganisms captured by the filter medium 14 are destroyed by the reactive oxidative species whereby a purified air stream is directed from the filter medium 14 toward the duct outlet 20.

Sterilization time is reduced by injecting a gas additive into the APD 12 in order to enhance the concentration and/or type of the reactive oxidative species generated by the atmospheric plasma. Similarly, a liquid additive in droplet or vaporous form may be injected into the APD 12 in order to enhance the concentration and/or type of the reactive oxidative species generated by the atmospheric plasma.

The APD 12 predominantly operates in atmospheric air. However, for all other gases including but not limited to oxygen, helium, nitrogen and carbon dioxide, the APD 12 operates at or above normal pressure. Accordingly, the term “atmospheric plasma” includes plasma that may be generated at atmospheric pressure, but also includes plasma generated at pressures greater than atmospheric pressure.

In the deployment illustrated in FIG. 1, the APD 12 is positioned upstream from the filter medium 14, with both the APD 12 and the filter medium 14 being positioned within the air stream. The contaminated air passes through and/or around the APD 12 and serves to carry with it the reactive oxidative species generated by the atmospheric plasma, the atmospheric plasma having been generated by the APD 12. As the contaminated air travels through the filter medium 14, microorganisms are captured both on the surface and within the filter medium 14 and are then destroyed by the reactive oxidative species.

A scrubber 38 is illustrated in phantom in FIG. 1. Under certain conditions, it is desirable to clean the filtered air in order to remove byproducts from the atmospheric plasma. For example, a known byproduct of the atmospheric plasma is ozone. While some levels of ozone are acceptable, there are those situations where complete removal is desirable. D Accordingly, the installation of a scrubber 38 provides the ability to remove such byproduct.

In the deployment illustrated in FIG. 2, a secondary duct 26 is provided. The secondary duct 26 opens into the primary air duct 16 through a secondary inlet 22 at a location upstream from the filter medium 14. The reactive oxidative species are convected into the primary air duct 16 and then toward the filter medium 14 as described in the previous embodiment. In this embodiment, the APD 12 is out of the contaminated air stream. As in FIG. 1, a scrubber 38 is shown in phantom as being provided if necessary to remove byproducts from the atmospheric plasma.

FIG. 3 illustrates a further deployment of the present invention wherein recirculation of the air is established. The APD 12 and filter medium 14 are disposed as in FIG. 1. A secondary outlet 24 is provided downstream from the filter medium 14 and a secondary inlet 22 is provided upstream from the APD 12. The secondary outlet 24 and the secondary inlet 22 are in fluid communication with each other via a secondary duct 26. A first closure device 30 such as the illustrated flap is disposed upstream from the secondary inlet 22, and a second closure device 30 is disposed downstream from the secondary outlet 24. When each of the first and second closure devices 30 are actuated, a closed loop is established and includes the APD 12 and the filter medium 14. A fan or blower 28 is disposed within the closed loop in order to move air within the loop. Thus, the concentration of the reactive oxidative species can be increased effecting sterilization more rapidly. This configuration is especially useful in situations where byproducts such as ozone are generated. The recirculation of the air serves to minimize the amount of air contaminated with such byproducts. As in the previous embodiments, a scrubber 38 is shown in phantom as being provided if necessary to remove byproducts from the atmospheric plasma.

A further deployment wherein recirculation of the air is accomplished is illustrated in FIG. 4. In this embodiment, the filter medium 14 is positioned within the primary air duct 16, and an APD 12 is D positioned within a secondary duct 26. The secondary duct 26 effectuates fluid communication between a secondary outlet 24 disposed downstream from the filter medium 14 and a secondary inlet 22 disposed upstream of the filter medium 12. As in the previous embodiment, a first closure device 30 such as the illustrated flap is disposed upstream from the secondary inlet 22, and a second closure device 30 is disposed downstream from the secondary outlet 24 such that when each of the first and second closure devices 30 are actuated, a closed loop is established. Again, the APD 12 and the filter medium 14 are disposed within the closed loop. A fan or blower 28 is disposed within the closed loop in order to move air within the loop. Again, as in the previous embodiments, a scrubber 38 is shown in phantom as being provided if necessary to remove byproducts from the atmospheric plasma.

Although not illustrated, the reactive oxidative species may be introduced through the secondary inlet 22 via a baffling system, the baffling system serving to accumulate the reactive oxidative species prior to convection into the primary air duct 16. In this manner, the air passing through the filter medium 14 is recirculated to accumulate the reactive oxidative species.

In another alternate embodiment, only a portion of the filter medium 14 is sterilized at one time. In such an embodiment, the APD 12 is smaller, requiring a smaller power supply and producing a smaller quantity of byproducts. In order to sterilize the entire filter medium 14 the APD 12 and filter medium 14 are moved relative to each other. To wit, either the APD 12 is moved in front of the filter medium 14, or vice versa.

The atmospheric plasma is produced by either a radio frequency (RF) electric field, an alternating current (AC) electric field, or a direct current (DC) electric field for generating said atmospheric plasma. In the embodiment wherein an RF electric field is produced, the RF electric field is tuned to trap ions resulting from the atmospheric plasma. In the embodiment wherein a DC electric field is produced, the DC electric field may be pulsed.

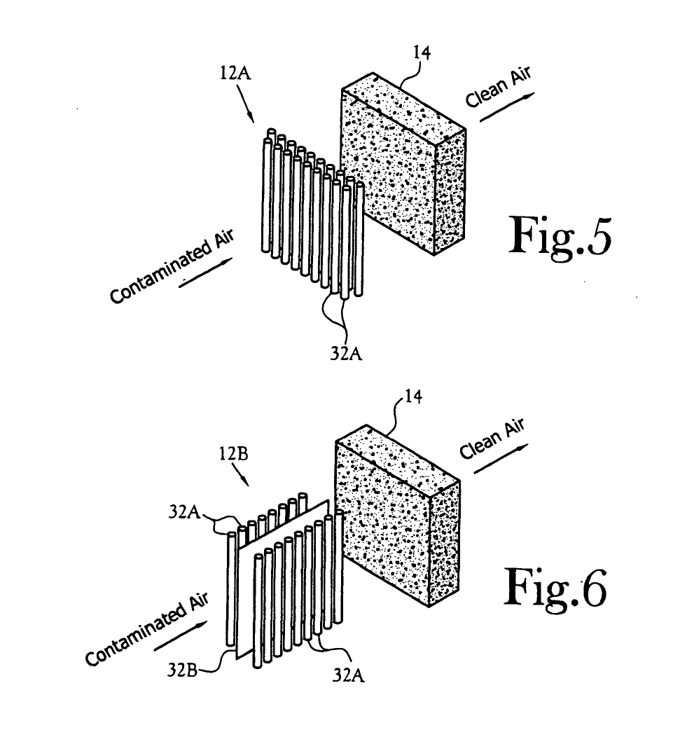

The APD 12 consists of two sets of electrodes 32 between which the electric field is produced. One set, both sets, or neither set of electrodes 32 is insulated. The electrodes 32 are fabricated from conductive wires, rods, plates, or meshes. The electrodes 32 can be parallel, curved, or tubular. The pair of electrodes 32 comprises one or a combination of these electrode configurations. FIGS. 5-10 illustrate several embodiments of the APD electrodes 32. However, it will be understood by those skilled in the art that other various arrangements and configurations are anticipated. For example, although not shown, the pair of electrodes may comprise a pair of concentric tubes.

As illustrated in FIG. 5 one preferred electrode arrangement of the APD 12A includes two sets of conducting wires or rods 32A. Each set of rods 32A is disposed in series, with the two sets of rods 32A lying in parallel planes orthogonal to the air stream. As illustrated, the contaminated air serves to convect the reactive oxidative species toward the filter medium 14, from which is delivered clean air. This arrangement, as well as those illustrated in FIGS. 6-10, is as best illustrated in FIGS. 1 and 3 above. For those arrangements illustrated in FIGS. 2 and 4, the APD 12 is moved to the secondary duct 26 such that the air stream reaching the filter medium 14 is a mixture of contaminated air and the secondary air stream laden with the reactive oxidative species.

The APD 12B illustrated in FIG. 6 comprises two sets of conducting wires or rods 32A separated by an electrode plate 32B. Each set of rods 32A is disposed in series and parallel to the contaminated air stream. The electrode plate 32B is also disposed parallel to the contaminated air stream. As in the previous embodiment, when this embodiment is deployed in the arrangement illustrated in FIGS. 2 and 4, the sets of rods 32A and the plate 32B are disposed parallel with the secondary air stream.

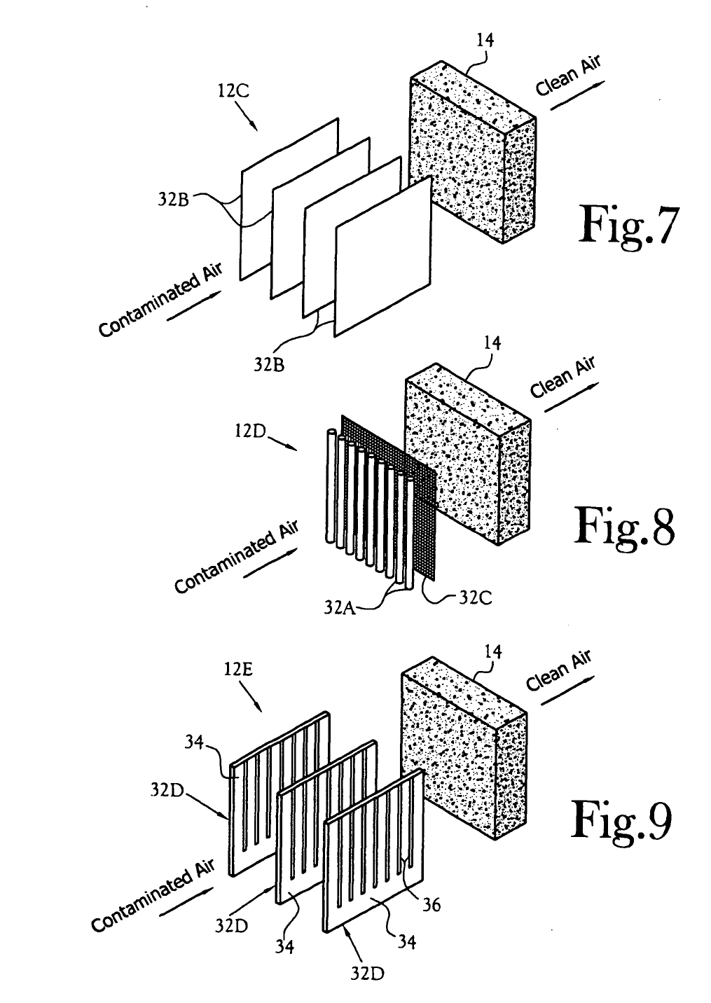

FIG. 7 illustrates an APD 12C comprising a set of parallel plates 32B. These plates 32B are disposed parallel to the air stream and generate an oxidative gas. These plates 32B are distinguished from plates which create an electric field for trapping dust and particulates.

FIG. 8 illustrates an APD 12D comprising a set of conductive wires or rods 32A and a mesh 32C. The set of conductive wires or rods 32A are disposed parallel to each other and in a plane orthogonal to the air stream. The mesh 32C is disposed in parallel to and downstream from the conductive rods 32A. It will be understood that this arrangement can be reversed.

As illustrated in FIG. 9, another APD 12E includes a set of parallel plasma panels 32D. Each plasma panel 32D is defined by a plate 34 having conducting wires 36 disposed on the surface of at least one side thereof. The plasma panels 32D are illustrated as being parallel to the air stream.

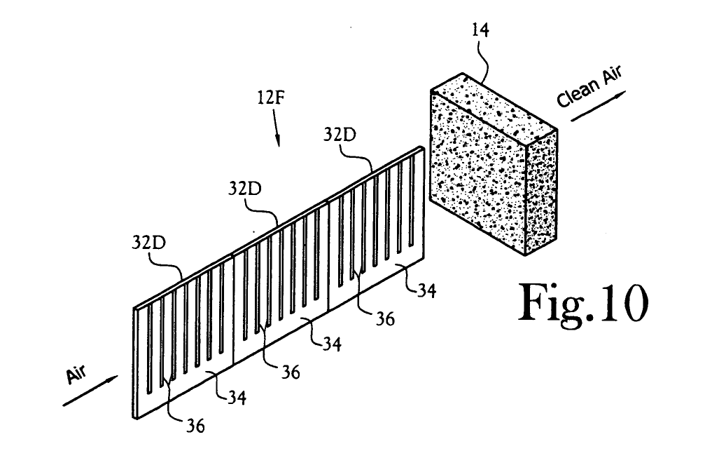

Similar to the embodiment of FIG. 9, the APD 12F illustrated in FIG. 10 includes a series of plasma panels 32D disposed in an end-to-end fashion. The series of plasma panels 32D is disposed parallel to the air stream.

The accumulation of the reactive oxidative species is accomplished by disposing the electrodes 32 in a serpentine pattern. The air flowing through the electrodes 32 thus passed over a greater surface area and as a result accumulates more of the reactive oxidative species. It is envisioned that other dispositions of the electrodes 32 than those specifically illustrated and/or described fall within the scope of the present invention.

The method of the present invention includes the steps of:

providing a duct 16 through which an air stream laden with microorganisms is directed;

providing a plasma generator 12 for generating an atmospheric plasma;

providing a filter medium 14 downstream from the plasma generator 12 for capturing the microorganisms suspended in the air stream, the filter media 14 being adapted to receive and filter the entire air stream;

directing the air stream laden with microorganisms toward the filter medium 14;

capturing the microorganisms in the filter medium 14;

generating an atmospheric plasma using the plasma generator 12 thereby generating reactive oxidative species within the air stream; and

convecting a sufficient concentration of the reactive oxidative species onto and throughout the filter media 14, whereby the microorganisms captured by the filter medium 14 are destroyed and whereby a purified air stream is directed from the filter medium 14 toward the duct outlet 20.

Atmospheric plasma is generated by a corona discharge, OAUGDP™, dielectric barrier discharges, capillary discharges, microhollow cathode discharges, or microwaves. The downstream air filter 14 is a conventional air filter, an electrostatic air filter, or a HEPA grade air filter. Compatible materials include but are not limited to natural fibers, glass fibers, metallic filters, or polymer filters. The location and airflow velocity are crucial to sterilization of the captured microorganisms because the reactive species recombine rapidly. Tests have confirmed that OAUGDP™ rapidly sterilizes a polypropylene air filter located several inches downstream of the atmospheric plasma.

By utilizing this innovative technique, there is no requirement for development and testing of new air filter material. Most conventional filter media and designs can be sterilized using the method of the present invention. Further, the system of the present invention is readily adaptable into conventional HVAC systems.

The present invention establishes plasma parameters including voltage, frequency, and exposure times that are most compatible with a series of filter media. Testing was performed to analyze capture rate and sterilization efficacy for both bacteria and sub-micron viral particles.

The present invention serves to sterilize the filter medium 12 located downstream of the plasma. One example of testing has shown that a fifteen second sterilizing exposure results in a reduction of 99.999% (5 logs) of the bacterial organisms located 3 inches downstream of the plasma source 12.

Sterilization experiments were conducted for surface and HEPA filters and revealed that sterilization could be achieved throughout the filter media in seconds to minutes depending upon the microorganism and the filter media. The reactive oxidative species created by the APD have been demonstrated to penetrate crevices and filter media to render the entire filter sterile.

From the foregoing description, it will be recognized by those skilled in the art that a device and method for the rapid sterilization of an air filter located downstream from an atmospheric plasma source offering advantages over the prior art has been provided. Generally, the present invention utilizes reactive oxidative species generated by an atmospheric plasma source disposed upstream from and convected downstream toward the filter medium. Captured microorganisms are killed in seconds to minutes. The location of the filter outside of the electrode array precludes constraints on the filter thickness and composition. In addition, the present invention allows electrostatic filters to remain charged due to their location outside the vicinity of the atmospheric plasma. The present invention destroys microorganisms captured on filtration media in order to control airborne biological agents including viruses, endospores, fungi, and bacteria. The present invention eliminates the requirement for a robust filter material. Further, the present invention eliminates the requirement for a complex electrode arrangement to sterilize the entire filter while not obstructing the airflow. Other deficiencies realized in prior methods that are overcome with the present invention include neutralization of embedded static charges on the filter surface as a result of an applied voltage; and alteration of the surface properties of the filter material.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of the general inventive concept.

Having thus described the aforementioned invention, we claim:

1. A method for killing airborne microorganisms, said method comprising the steps of:
a) providing a duct through which an air stream laden with microorganisms is directed, said duct defining an inlet and an outlet, the air stream travelling in the direction from said inlet to said outlet;
b) providing a plasma generator for generating atmospheric plasma;
c) providing a filter medium downstream from said plasma generator for capturing the microorganisms suspended in the air stream, said filter media being adapted to receive and filter the entire air stream;
d) directing the air stream laden with microorganisms toward said filter medium;
e) capturing the microorganisms in said filter medium;
f) generating an atmospheric plasma using said plasma generator thereby generating reactive oxidative species within the air stream; and
g) convecting a sufficient concentration of the reactive oxidative species onto and throughout said filter media, whereby the microorganisms captured by said filter medium are destroyed and whereby a purified air stream is directed from said filter medium toward said duct outlet.

2. The method of claim 1 wherein said step of providing a plasma generator is performed by providing a radio frequency (RF) electric field, and wherein said step of generating an atmospheric plasma is performed by said RF electric field.

3. The method of claim 2 wherein said atmospheric plasma is a One Atmospheric Uniform Glow Discharge Plasma and wherein said RF electric field is tuned to predominantly trap ions resulting from said One Atmosphere Uniform Glow Discharge Plasma.

4. The method of claim 1 wherein said step of providing a plasma generator is performed by providing an alternating current (AC) electric field, and wherein said step of generating an atmospheric plasma is performed by said AC electric field.

5. The method of claim 1 wherein said step of providing a plasma generator is performed by providing a direct current (DC) electric field, and wherein said step of generating an atmospheric plasma is performed by said DC electric field.

6. The method of claim 5 wherein said DC electric field is a pulsed DC electric field.

7. The method of claim 1 wherein said plasma generator is comprised of two sets of electrodes, each of said two sets of electrodes being selected from the group consisting of at least conductive wires, rods, plates, and meshes.

8. The method of claim 7 wherein said two sets of electrodes define a curved configuration.

9. The method of claim 7 wherein said two sets of electrodes define a tubular configuration.

10. The method of claim 7 wherein said two sets of electrodes are insulated.

11. The method of claim 7 wherein one of said two sets of electrodes is insulated.

12. The method of claim 7 wherein said two sets of electrodes are uninsulated.

13. The method of claim 1 wherein said plasma generator is a microwave.

14. The method of claim 1 wherein said step of generating an atmospheric plasma using said plasma generator thereby generating reactive oxidative species within the air stream is performed within the stream of air laden with microorganisms, and wherein said step of convecting a sufficient concentration of the reactive oxidative species onto and throughout said filter media is accomplished by said stream of air laden with microorganisms.

15. The method of claim 1 wherein said duct defines a secondary inlet upstream from said filter medium, whereby said step of generating an atmospheric plasma using said plasma generator thereby generating reactive oxidative species within the air stream is performed outside the stream of air laden with microorganisms and within a secondary air stream directed into said duct through said secondary inlet, and wherein said step of convecting a sufficient concentration of the reactive oxidative species onto and throughout said filter media is accomplished by said secondary air stream.

16. A device for killing microorganisms from an air stream directed through a duct, said duct defining an inlet and an outlet, said device comprising:
a filter medium disposed within said duct for capturing the microorganisms suspended in the air stream, said filter media being adapted to receive and filter the entire air stream; and
a plasma generator disposed upstream from said filter medium for generating an atmospheric plasma, said atmospheric plasma generating reactive oxidative species within the air stream, the air stream convecting the reactive oxidative species from the atmospheric plasma toward said filter medium, whereby the microorganisms captured by said filter medium are destroyed and whereby a purified air stream is directed from said filter medium toward the duct outlet.

17. The device of claim 16 wherein said plasma generator produces a radio frequency (RF) electric field for generating said atmospheric plasma.

18. The device of claim 17 wherein said atmospheric plasma is a One Atmospheric Uniform Glow Discharge Plasma and wherein said RF electric field is tuned to predominantly trap ions resulting from said One Atmosphere Uniform Glow Discharge Plasma.

19. The device of claim 16 wherein said plasma generator produces an alternating current (AC) electric field for generating said atmospheric plasma.

20. The device of claim 16 wherein said plasma generator produces a direct current (DC) electric field for generating said atmospheric plasma.

21. The device of claim 20 wherein said DC electric field is a pulsed DC electric field.

22. The device of claim 16 wherein said filter medium is selected from the group consisting of at least a bulk filter medium, a surface filter, an electrically enhanced filter medium, and a charged filter medium.

23. The device of claim 16 wherein said plasma generator is comprised of two sets of electrodes, each of said two sets of electrodes being selected from the group consisting of at least conductive wires, rods, plates, and meshes.

24. The device of claim 23 wherein said two sets of electrodes define a curved configuration.

25. The device of claim 23 wherein said two sets of electrodes define a tubular configuration.

26. The device of claim 23 wherein said two sets of electrodes are insulated.

27. The device of claim 23 wherein one of said two sets of electrodes is insulated.

28. The device of claim 23 wherein said two sets of electrodes are uninsulated.

29. The device of claim 16 wherein said plasma generator is a microwave.

30. A device for killing microorganisms from an air stream, said device comprising:
a duct defining a primary inlet, a secondary inlet and an outlet, said duct being adapted to receive an air stream laden with microorganisms through said primary inlet and directed toward said outlet, said secondary inlet being disposed between said primary inlet and said outlet and being adapted to direct a secondary air stream into said duct and toward said outlet;
a filter medium disposed within said duct between said secondary inlet and said outlet for capturing the microorganisms suspended in the air stream, said filter media being adapted to receive and filter the entire air stream; and
a plasma generator disposed within said secondary air stream for generating an atmospheric plasma, said atmospheric plasma generating a reactive oxidative species within said secondary air stream, said secondary air stream convecting the reactive oxidative species from the atmospheric plasma into said secondary inlet toward said filter medium, whereby the microorganisms captured by said filter medium are destroyed and whereby a purified air stream is directed from said filter medium toward the duct outlet.

31. The device of claim 30 wherein said plasma generator produces a radio frequency (RF) electric field for generating said atmospheric plasma.

32. The device of claim 31 wherein said atmospheric plasma is a one atmospheric uniform glow discharge and wherein said RF electric field is tuned to predominantly trap ions resulting from said one atmosphere uniform glow discharge plasma.

33. The device of claim 30 wherein said plasma generator produces an alternating current (AC) electric field for generating said atmospheric plasma.

34. The device of claim 30 wherein said plasma generator produces a direct current (DC) electric field for generating said atmospheric plasma.

35. The device of claim 34 wherein said DC electric field is a pulsed DC electric field.

36. The device of claim 30 wherein said filter medium is selected from the group consisting of at least a bulk filter medium, a surface filter, an electrically enhanced filter medium, and a charged filter medium.

37. The device of claim 30 wherein said plasma generator is comprised of two sets of electrodes, each of said two sets of electrodes being selected from the group consisting of at least conductive wires, rods, plates, and meshes.

38. The device of claim 37 wherein said two sets of electrodes define a curved configuration.

39. The device of claim 37 wherein said two sets of electrodes define a tubular configuration.

40. The device of claim 37 wherein said two sets of electrodes are insulated.

41. The device of claim 37 wherein one of said two sets of electrodes is insulated.

42. The device of claim 37 wherein said two sets of electrodes are uninsulated.

43. The device of claim 1 wherein said plasma generator is a microwave.
